(19) United States
(12) Patent Application Publication
(10) Pub. No.: US 2006/0127548 A1
(43) Pub. Date: Jun. 15, 2006

(54) Apparatus and method for dispensing a softened edible substance for decorating foodstuffs

(76) Inventor: Hideko Nakanishi, Rogers, AR (US)

Correspondence Address: JAMES RAY & ASSOCIATES, 2640 PITCAIRN ROAD, MONROEVILLE, PA, 15146, US

(21) Appl. No.: 11/296,563

(22) Filed: Dec. 7, 2005

Related U.S. Application Data
(60) Provisional application No. 60/635,134, filed on Dec. 10, 2004.

(51) Int. Cl. A23G 3/28

(52) U.S. Cl. 426/383

(57) ABSTRACT

An apparatus for dispensing a softened edible substance for decorating foodstuffs includes a housing having an inlet port for receiving the edible substance of in a solid form, an outlet port and a chamber connecting the inlet port and the outlet port. A nozzle engages the housing adjacent the outlet port. A heating means is provided within the housing for heating a portion of the chamber disposed adjacent the outlet port and a portion of the edible substance disposed within the chamber portion to a temperature of less than 110 degrees Fahrenheit. A power supply means is coupled to the heating means for selectively activating and deactivating operation thereof.

### CROSS-REFERENCE TO RELATED APPLICATIONS

This application is related to and claims priory from Provisional Patent Application Ser. No. 60/635,134 filed Dec. 10, 2004.

### FIELD OF THE INVENTION

The present invention relates, in general, to apparatus and methods for dispensing softened edible substances for decorating foodstuffs and, more particularly, this invention relates to a hand held apparatus for dispensing a softened edible substance such as chocolate, other flavored candies, frosting, icing and the like onto foodstuffs, in particular, baked goods such as cakes, tortes, cookies, pastries and the like.

### BACKGROUND OF THE INVENTION

As is generally well known, decorating of foodstuffs, and in particular baked goods such as cakes, tortes, cookies, pastries and the like is performed by using a baker's pastry bag filled with the decorating substance such as frosting, icing or chocolate and applying manual force, usually significant, to squeeze the bag and force the decorating substance through the nozzle and onto the baked goods. Chocolate, in particular, must be first softened, usually by heat, external to such pastry bag and then dispensed onto the baked goods prior to the chocolate returning to a solidified form. Any unused chocolate or the solidified chocolate in the pastry bag must be reheated prior to the next decorating application.

The force required to squeeze the substance from the pastry bag may cause the user's hands to become fatigued, particularly, in a commercial cake decorating environment requiring frequent resting which increases the cost of decorating the baked goods.

Chocolate heating and reheating as well as clean up of the container used for its heating further increase decorating costs.

Therefore, there is a need for an improved apparatus and method for dispensing softened food decorating substances such as chocolate, frosting, icing and the like onto baked goods such as cakes, tortes, pastries and the like which do not require significant manual force and reduce decorating costs.

### SUMMARY OF THE INVENTION

According to one aspect, the invention provides an apparatus for dispensing a softened edible substance for decorating foodstuffs. The apparatus includes a housing having a predetermined shape and having an inlet port for receiving an edible substance of a solid form and an outlet port. A chamber is disposed within the housing and connects the inlet port and the outlet port. A nozzle engages the housing adjacent the outlet port. A heating means is provided within the housing for heating a portion of the chamber disposed adjacent the outlet port and a portion of the edible substance disposed within the chamber portion to a temperature of less than 110 degrees Fahrenheit, sufficient to self extrude the edible substance through the nozzle. A power supply means is coupled to the heating means for selectively activating and deactivating operation thereof.

According to another aspect, the invention provides a method of decorating foodstuffs which includes a step of inserting an edible substance having a solid form into such apparatus, a step of heating a portion of such edible substance to a temperature of less than 110 degrees Fahrenheit and a step of extruding it through the nozzle.

According to yet another aspect, the invention provides an edible substance having an elongated shape for use with an apparatus for decorating foodstuffs.

### OBJECTS OF THE INVENTION

It is, therefore, one of the primary objects of the present invention to provide apparatus and method for dispensing softened edible substances for decorating foodstuffs.

Another object of the present invention is to provide apparatus and method for dispensing softened edible substances without a need for significant manual force.

Yet another object of the present invention is to provide an apparatus for dispensing softened edible substances which can preheat such edible substances provided in a solid form.

A further object of the present invention is to provide an apparatus for dispensing softened edible substances which is simple to use.

Yet a further object of the present invention is to provide an apparatus for dispensing softened edible substances which is simple and economical to manufacture.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a cross-sectional view of an apparatus for dispensing a softened edible substance for decorating foodstuffs according to one embodiment of the invention; and

FIG. 2 is an elevation view of an apparatus for dispensing a softened edible substance for decorating foodstuffs according to another embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of an edible substance applies to chocolate, frosting, icing and like food materials presently utilized in decoration of foodstuffs.

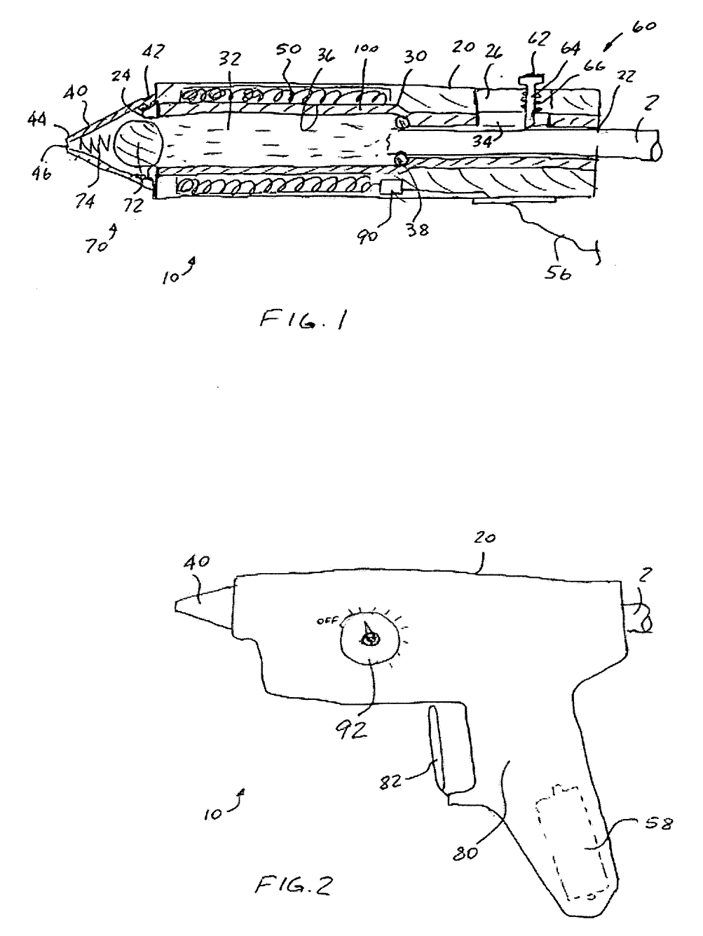

Reference is now made, to FIGS. 1-2, wherein there is shown an apparatus, generally designated 10, for dispensing a softened edible substance 2 for decorating foodstuffs. Such apparatus 10 includes a housing 20 having a predetermined shape, an inlet port 22 for receiving the edible substance having a solid form and an outlet port 24. Advantageously, the shape of the housing 20 may resemble a writing instrument such as a pen or pencil.

A chamber 30 is disposed within the housing 20 and operably connects the inlet port 22 with the outlet port 24. Preferably, the chamber 30 is washable. It is further preferred that the chamber 30 is formed from a material preventing contamination of the edible substance, such as stainless steel. The chamber 30 may be provided with a sealing means 38, such as an O-ring, disposed in a predetermined location of the chamber 30 and in contact with a solid portion of the edible substance 2 for preventing escape of the heated edible substance 2 in a direction towards the inlet port 22.

A nozzle 40 is provided for dispensing such edible substance 2 onto the foodstuff. The nozzle 40 generally has a first end 42 adapted for removable engagement with the housing 20 adjacent the outlet port 24 and an opposed second end 44 adapted with an aperture 46 having each of a predetermined shape and a predetermined size for controlling volume and shape of the edible substance 2 exiting such nozzle 40.

A heating means 50 is mounted in the housing 20 for heating a first portion 32 of the chamber 30 disposed adjacent the outlet port 24 and a portion of the edible substance 2 disposed within the chamber interior portion 32. In the presently preferred embodiment of the invention, such heating means 50 is an electrically operable coil 50 at least partially surrounding the first chamber interior portion 32. Such heating coil 50 is capable of heating the edible substance 2 to a temperature of less than 110 degrees Fahrenheit, sufficient to self extrude the edible substance 2 through the nozzle 40.

A power supply means 56 is coupled to the heating means 50 for selectively activating and deactivating operation thereof. Such power supply means 56 is an electrical cord 56 for connecting heating means 50 to an electrical outlet (not shown). Alternatively, such heating means 50 may be a battery means 58, best seen in FIG. 2.

In order to decorate foodstuffs, the edible substance 2 is formed into a solid shape capable of being received by the chamber 30 through the inlet port 22. Preferably, the edible substance 2 has an elongated shape of a predetermined length and a predetermined cross-section. The presently preferred cross-section is substantially round forming a cylindrically shaped edible substance 2. It will be appreciated that such shape can be simply commercialized and manufactured. For example, a mixed chocolate batter can be extruded through a round shaped die and cut to such predetermined length prior to allowing such chocolate batter to solidify. It will be appreciated that the edible substance 2 may be refrigerated or frozen to improve handling thereof.

One end of the edible substance 2 is inserted into the inlet port 22 and the edible substance 2 is manually pushed into the first chamber 32. The heating means 50 is activated to heat the first chamber 32 and the edible substance 2 contained therein enabling it to self-extrude through the aperture 46 of the nozzle 40. When the edible substance 2 is substantially consumed, a new edible substance 2 of a solid shape is inserted into the inlet port 22 and such process is repeated until the decoration is completed.

Alternatively, in a hand held embodiment of the apparatus 10, a manually controlled feeding means, generally designated 60, may be incorporated into the housing 20 adjacent the inlet port 22 for progressively feeding the edible substance 2 having the solid form towards the nozzle 40 in order to apply a predetermined pressure onto the heated portion of the edible substance 2.

According to one embodiment of the invention, such manually controlled feeding means 60 includes an actuating member 62 operable from the outer surface of the housing 20 and a stem portion 64 extending outwardly from such actuating member 62 through an elongated slot 26 in the housing 20 and a complimentary elongated slot 34 in the chamber 30. A spring means 66, caged is between a predetermined portion of the housing 20 and the actuating member 62. Spring means 66 is provided to bias the feeding means 60 away from engagement with the edible substance 2.

In operation, the actuating member 62 is first pressed enabling the stem portion 66 to engage the edible substance 2 and then moved in a direction of the nozzle 40, guided by the slots 26 and 34, to feed such edible substance 2 in the direction of the nozzle 40.

In such embodiment, the solid portion of the edible substance 2 is progressively fed towards the nozzle 40 to apply a predetermined pressure onto the heated portion of such edible substance 2 enabling its extrusion through the aperture 46 of the nozzle 40. When the solid portion of the edible substance 2 is substantially consumed, a new edible substance 2 of a solid shape is inserted into the inlet port 22 and such process is repeated until the decoration is completed.

The apparatus 10 may further include means, generally designated 70, disposed within the nozzle 40 for preventing exit of the heated edible substance 2 when application of the predetermined pressure is discontinued. Such means 70 may be a well known check valve 70 having a ball 72 biased by the spring 74 towards the outlet port of 24 of the housing 20 to plug the end of the chamber 30.

The apparatus 10 may be provided with a grip means 80 extending outwardly from the housing 20 preferably adjacent the inlet port 22 and forming a pistol like shape of the apparatus 10. In such embodiment, the apparatus 10 includes a trigger means 82 disposed within the grip means 80 for operating the manually controlled feeding means 60. It will be apparent to those skilled in the art that any feeding means 60 controlled by a trigger means 82 presently utilized for dispensing melted adhesives may be adapted in the present invention to progressively feed the edible substance 2 towards the nozzle 40.

U.S. Pat. No. 3,743,142 to Elliott et al; U.S. Pat. No. 4,032,046 to Elliott et all; U.S. Pat. No. 4,804,110 to Sperry et all; and U.S. Pat. No. 5,026,188 to Capodieci teach various feeding means 60 suitable for use with the present invention. Teachings of U.S. Pat. No. 3,743,142; U.S. Pat. No. 4,032,046; U.S. Pat. No. 4,804,110; and U.S. Pat. No. 5,026,188 are incorporated into this document by reference thereto.

In further reference to FIG. 2, the apparatus 10 may be further provided with a temperature control means 90 coupled intermediate the heating means 50 and the power supply means 58 for controlling temperature of the heating means 50. Such temperature control means 90 may be a thermostat 90 which may be further regulated by a switch means 92 operable from the outer surface of the housing 20. Such switch means 92 may be advantageously mounted on the outer surface of the housing 20.

The apparatus 10 may be additionally provided with a sleeve 100 removably mounted within the chamber 30 intermediate the edible substance 2 and a peripheral wall 36 of the chamber 30. The sleeve 100 may be formed from a material preventing contamination of the edible substance, such as stainless steel. It will be appreciated that the removable sleeve 100 enables manufacturing the apparatus 10 from an economical material, such as thermoplastics and enhances cleaning of the apparatus 10.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An apparatus for dispensing a softened edible substance for decorating foodstuffs, said apparatus comprising:
(a) a housing having a predetermined shape, an inlet port for receiving an edible substance having a solid form and an outlet port;
(b) a chamber disposed within said housing connecting said inlet port and said outlet port;
(c) a nozzle engageable with said housing adjacent said outlet port;
(d) a heating means mounted in said housing for heating a portion of said chamber disposed adjacent said outlet port and a portion of such edible substance disposed within said chamber portion to a temperature of less than 110 degrees Fahrenheit, which is at least sufficient to self extrude such edible substance through said nozzle; and
(e) a power supply means coupled to said heating means for selectively activating and deactivating operation thereof.

2. The apparatus, according to claim 1, wherein said apparatus further includes a means engageable with said housing adjacent said inlet port for progressively feeding such edible substance having such solid form towards said nozzle to apply a predetermined pressure onto said heated portion of such edible substance.

3. The apparatus, according to claim 2, wherein said feeding means is manually operable.

4. The apparatus, according to claim 3, wherein said manually operable feeding means includes an actuating member operable from an outer surface of said housing, a stem portion extending outwardly from said actuating member through a first elongated slot formed in said housing and a complimentary second elongated slot formed in said chamber, and a spring means caged between a predetermined portion of said housing and said actuating member for biasing said feeding means away from engagement with such solid portion of such edible substance, whereby said actuating member is first pressed in a direction towards said housing causing said stem portion to engage a solid portion of such edible substance and then moved in a direction towards said nozzle, guided by a combination of said first elongated slot and said second elongated slot.

5. The apparatus, according to claim 2, wherein said apparatus further includes a means disposed within said nozzle for preventing exit of such heated edible substance when application of said predetermined pressure is discontinued.

6. The apparatus, according to claim 1, wherein said heating means is a coil.

7. The apparatus, according to claim 1, wherein said apparatus further includes a grip means extending outwardly from said housing adjacent said inlet port and forming a pistol like shape of said apparatus.

8. The apparatus, according to claim 7, wherein said apparatus further includes a trigger means disposed within said handle for operating a feeding means for progressively feeding such edible substance having such solid form towards said nozzle.

9. The apparatus, according to claim 1, wherein said apparatus further includes a temperature control means coupled intermediate said heating means and said power supply means for controlling temperature of said heating means.

10. The apparatus, according to claim 1, wherein said power supply means is one of an electrical cord and battery.

11. The apparatus, according to claim 1, wherein said apparatus further includes a sleeve removably disposed within said chamber intermediate such edible substance and a peripheral wall of said chamber;

12. The apparatus, according to claim 11, wherein said sleeve is formed from a material preventing contamination of such edible substance.

13. The apparatus, according to claim 12, wherein said material is stainless steel.

14. The apparatus, according to claim 1, wherein said apparatus further includes a sealing means disposed in a predetermined location within said chamber and in contact with such edible substance having such solid form for preventing escape of such heated edible substance in a direction towards said inlet port.

15. The apparatus, according to claim 1, wherein said chamber is washable.

16. A method for decorating foodstuffs, said method comprising the steps of:
(a) providing an apparatus capable of heating and dispensing an edible substance through a nozzle of said apparatus;
(b) providing said edible substance having a solid form;
(c) inserting one end of said solid edible substance into said apparatus;
(d) heating a portion of said edible substance disposed adjacent said nozzle of said apparatus to a temperature of less than 110 degrees Fahrenheit, which is at least sufficient to self extrude said edible substance through said nozzle;
(e) extruding said heated edible substance heated in step (d) through said nozzle of said apparatus; and
(f) applying said extruded edible substance onto said foodstuffs.

17. The method, according to claim 17, wherein said apparatus is capable of feeding said edible substance towards said nozzle and said method further includes a step of progressively feeding said solid edible substance towards said nozzle to apply a predetermined pressure onto said heated portion of said edible substance.

18. An edible solid substance for use with an apparatus for decorating foodstuffs, said edible solid substance having an elongated shape of a predetermined length and a predetermined cross-section.

19. The edible substance, according to claim 18, wherein said predetermined cross-section is substantially round.

20. The edible substance, according to claim 18, wherein said edible solid substance is one of chocolate, frosting, icing and various combinations thereof.
